(19) United States
(12) Patent Application Publication
(10) Pub. No.: US 2006/0082958 A1
(43) Pub. Date: Apr. 20, 2006

(54) Electronic equipment

(75) Inventor: Yasuhito Fujiwara, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/248,210

(22) Filed: Oct. 13, 2005

(30) Foreign Application Priority Data
Oct. 15, 2004 (JP) 2004-301976

(51) Int. Cl. G06F 1/16

(52) U.S. Cl. 361/681; 248/917

(57) ABSTRACT

According to an embodiment, tips of a pair of arms extending from a front end surface of a display unit of a facsimile apparatus are rotatably supported by a hinge mechanism so that a display unit can be tilted up. A key operation section is provided in front of the display unit, and a key operation section control circuit substrate is accommodated under the key operation section. The arm is extended under the key operation section control circuit substrate, and the center of rotation of the arm is disposed below the key operation section control circuit substrate.

### CROSS REFERENCE TO RELATED APPLICATIONS

This application claims priority under 35 U.S.C. § 119(a) on Patent Application No. 2004-301976 filed in Japan on Oct. 15, 2004, the entire contents of which are hereby incorporated by reference.

### BACKGROUND OF THE INVENTION

1. Field of the Invention

The present invention relates to an electronic equipment comprising a rotatable unit, such as a rotatably-supported display unit or the like. More particularly, the present invention relates to an improvement in a rotatable unit supporting mechanism.

2. Related Art

Conventionally, there is known electronic equipment, such as a facsimile apparatus, a telephone, a notebook computer, and the like, which includes a display unit which can be tilted up and down. The display unit is tilted up and used as required (see, for example, JP 2002-100883 A, which is hereinafter referred to as “Patent Document 1”). Particularly in recent years, the variety of contents displayed on a display unit has been increased with the development of information technology (IT). In addition, liquid crystal display panels (hereinafter referred to as “LCD panels”) have been upsized with the progress of LCD (liquid crystal display apparatus) manufacturing technology. Therefore, a large-size LCD panel is becoming to be employed as the display unit.

Conventionally, a display unit is supported in a manner which allows it to be tilted up and down, by generally employing the following structure. As illustrated in FIGS. 11(a) and 11(b) (rough diagrams of a display unit 101 and its vicinity when viewed from a side thereof; in the diagrams, the left-hand side is a front side of the apparatus, and the user operates the apparatus from the left-hand side), a hinge mechanism is provided at a lower portion of the front end (a lower left corner portion in the diagrams) of the display unit 101. The display unit 101 is tilted up about a rotation axis 102 of the hinge mechanism. FIG. 11(a) illustrates a state of the display unit 101 (retracted state) before it is tilted up, and FIG. 11(b) illustrates a state of the display unit 101 which is tilted up.

However, in this structure, it is necessary that an extra space 104 be provided at a portion of an apparatus casing 103 (a portion to which the front end portion of the display unit 101 is shifted) so as to prevent the front end portion of the display unit 101 (a lower end portion when the display unit 101 is tilted up) from interfering with the apparatus casing 103 when the display unit 101 is tilted up. In this case, not only the outer appearance is poor in the retracted state, but also foreign matter enters the space 104, likely leading to obstruction of the tilt-up operation. In addition, the presence of the space 104 puts a limitation on space for arrangement of operation buttons, so that a high degree of freedom can no longer be achieved for the layout of operation buttons.

Alternatively, as illustrated in FIGS. 12(a) and 12(b), the need for the space 104 may be eliminated by providing the rotation axis 102 of the hinge mechanism at an upper portion of the front end of the display unit 101. In this case, however, there is a possibility that the presence of the hinge mechanism is visually recognized from a surface of the apparatus, resulting in a poor outer appearance.

To avoid these disadvantages, a supporting mechanism disclosed in Patent Document 1 has been proposed. FIGS. 13(a) and 13(b) are rough diagrams schematically illustrating the supporting mechanism disclosed in Patent Document 1, and illustrating a cross-section of the apparatus casing 103. As illustrated in FIGS. 13(a) and 13(b), an arm 105 which extends forward from a lower portion of the front end of the display unit 101, and the rotation axis 102 of the hinge mechanism is located at a tip portion of the arm 105. With this structure, the extra space 104 (see FIG. 11(a)) for rotating the display unit 101 is no longer required, and the hinge mechanism is not visually recognized from the apparatus surface, resulting in a good outer appearance.

Note that a member which is rotated with respect to an apparatus casing as described above, i.e., a rotatable unit, is not limited to the above-described display unit, and may be an operation unit with various operation keys.

However, in the above-described structure disclosed in Patent Document 1, the rotation axis 102 of the hinge mechanism is located above a control circuit substrate 106, and therefore, there is the following drawback.

Specifically, in the apparatus provided with the display unit 101 which can be freely tilted up, a hollow portion 107 for accommodating the display unit 101 in the retracted state is provided on an upper surface of the apparatus, and an opening 109 for inserting the arm 105 is formed on a vertical wall 108 at a front end of the hollow portion 107. The opening 109 needs to be relatively large so that the movement of the arm 105 is allowed to range from the retracted state (FIG. 13(a)) to the maximally tilted-up state (FIG. 13(b)) of the display unit 101 (i.e., the opening 109 does not interfere with the arm 105).

In such a situation, if foreign matter or water enters between the front end edge of the display unit 101 and the vertical wall 108 at the front end of the hollow portion 107 when the display unit 101 is in the retracted state (see arrow 110 in FIG. 13(a)), the foreign matter or water may fall through the opening 109 on the control circuit substrate 106 to have an adverse influence on the operation. Such a drawback does not occur in the hinge structures of FIGS. 11(a), 11(b), 12(a), and 12(b), since an opening does not need to be provided on the vertical wall of the hollow portion. However, in the case of the structure in which the display unit 101 can be freely tilted up via the arm 105 as disclosed in Patent Document 1, such a drawback occurs.

To overcome this drawback, a control circuit substrate may be covered with a protection member for protecting against foreign matter or water. In this case, disadvantageously, the number of parts is increased and a process of attaching the protection member is complicated.

As described above, an effective solution to the drawbacks has not been proposed. The present inventors paid attention to the newly arising drawbacks, and studied an improvement of the practicability of the mechanism which supports the display unit 101 in a manner which allows the display unit 101 to be freely tilted up and down.

### SUMMARY OF THE INVENTION

The present invention is provided to solve the above-described problems. An object of the present invention is to provide a structure which can satisfactorily protect a control circuit substrate, with respect to an electronic equipment in which a rotatable unit is tilted up and down about a tip of an arm extending from the rotatable unit as a center of rotation.

An electronic equipment comprises an equipment casing, a control circuit substrate accommodated and disposed in the equipment casing, and a rotatable unit rotatably supported by a supporting mechanism accommodated in the equipment casing, and capable of being tilted up and down with respect to a surface of the equipment casing. The supporting mechanism is disposed closer to an opposite surface of the equipment casing than an imaginary plane including a plate surface of the control circuit substrate is.

In this case, a specific structure which rotatably supports the rotatable unit may be such that the rotatable unit comprises an arm penetrating through the equipment casing and extending inside the equipment casing, and the arm is rotatably supported by the supporting mechanism, whereby the rotatable unit is tilted up and down with a center of rotation thereof being provided closer to the opposite surface of the equipment casing than the imaginary plane is.

Alternatively, an electronic equipment of the present invention may comprise an equipment casing, a control circuit substrate accommodated and disposed in the equipment casing, and a rotatable unit rotatably supported by a supporting mechanism accommodated in the equipment casing, and capable of being tilted up and down with respect to an upper surface of the equipment casing. The control circuit substrate may be provided extending in a horizontal direction substantially parallel to the upper surface of the equipment casing within the equipment casing, and the supporting mechanism may be disposed closer to a bottom surface of the equipment casing than an imaginary horizontal plane including a plate surface of the control circuit substrate is.

Also in this case, a specific structure which rotatably supports the rotatable unit may be such that the rotatable unit comprises an arm penetrating through the equipment casing and extending inside the equipment casing, and the arm is rotatably supported by the supporting mechanism, whereby the rotatable unit is tilted up and down with a center of rotation thereof being provided closer to the bottom surface of the equipment casing than the imaginary horizontal plane is.

According to the electronic equipment thus constructed, when the rotatable unit is tilted up and down with respect to the equipment casing, the center of rotation of the rotatable unit is located at a position where the supporting mechanism is provided, i.e., closer to the opposite surface of the equipment casing than the imaginary plane including the plate surface of the control circuit substrate is. Generally, in such a supporting mechanism, an arm extends from the rotatable unit, and an opening for inserting the arm is formed in the equipment casing. There is a possibility that foreign matter or water enters through the opening. However, even in such a situation, an adverse influence on the control circuit substrate due to the foreign matter or water can be avoided since the control circuit substrate is located closer to the surface of the apparatus than the supporting mechanism is.

A more specific structure of the electronic equipment thus constructed may be such that the equipment casing is provided with a key operation section comprising a plurality of keys, and the control circuit substrate is disposed at a position facing the key operation section in a space of the equipment casing. In this structure, when the rotatable unit is tilted up, the rotatable unit is moved (jutted) toward the operation key side, i.e., the rotatable unit approaches the operation key. Therefore, after the rotatable unit is tilted up, keys can be satisfactorily operated while viewing the rotatable unit (e.g., a display unit comprising an LCD panel).

Further, the equipment casing may be provided with a hollow portion for accommodating the rotatable unit when the rotatable unit is retracted, and a surface of the rotatable unit in the retracted state and the surface of the equipment casing are on substantially the same plane. Thereby, an appearance of the electronic equipment in this retracted state can be improved.

In this case, a front surface of the rotatable unit facing a vertical wall of the hollow portion may be formed as a curved surface bent from a back surface toward a top surface of the rotatable unit, and the vertical wall of the hollow portion may be formed as a curved surface extending along the curved surface of the rotatable unit. According to this structure, when the rotatable unit is in the retracted state, a gap between a front end surface of the rotatable unit and the vertical wall of the hollow portion is not substantially visually recognized, so that a satisfactory outer appearance of the electronic equipment can be achieved. In addition, when the rotatable unit is rotated, a smooth rotation can be achieved without a front end portion thereof interfering with the vertical wall of the hollow portion.

As the rotatable unit, a portrait-type rotatable unit which has a first dimension in a rotation axis direction and a second dimension perpendicular to the first dimension, the second dimension being longer than the first dimension, may be employed. According to such a structure, an angle of rotation of the supporting mechanism portion can be caused to be small with respect to a movement distance in a rotational direction of a rear end of the rotatable unit (a portion farthest from the center of rotation). Thereby, a distance (radius of rotation) from the center of rotation to the rear end of the rotatable unit can be caused to be long due to the length of the arm. Force required to tilt up the rotatable unit can be caused to be small. Therefore, a fine adjustment can be easily performed when the user adjusts a tilt-up angle.

A specific structure of the rotatable unit may be composed of, for example, a display unit comprising inside a liquid crystal display apparatus.

As described above, in the present invention, the center of rotation of the rotatable unit is provided closer to the opposite surface of the equipment casing than the position where the control circuit substrate is provided is. Therefore, even if foreign matter or water enters an opening for inserting the arm extending from the rotatable unit into the apparatus casing when the rotatable unit is in the retracted state, it is possible to prevent the foreign matter or water from falling on the control circuit substrate, so that an adverse influence on the control circuit substrate can be avoided. As a result, the durability and reliability of the electronic equipment can be improved.

### BRIEF DESCRIPTION OF THE DRAWINGS

FIG. 1 is a perspective view illustrating a retracted state of a display unit in a facsimile apparatus according to an embodiment of the present invention.

FIG. 2 is a perspective view illustrating a maximally tilted-up state of the display unit in the facsimile apparatus according to the embodiment of the present invention.

FIG. 3 is a plan view illustrating a user interface portion of the apparatus when the display unit is in the retracted state.

FIG. 4 is a cross-sectional view of the display unit and a key operation section when viewed from a side thereof (a cross-sectional view taken along line IV-IV of FIG. 3), where the display unit is in the retracted state.

FIG. 5 is a plan view illustrating the user interface portion of the apparatus, where the display unit is in the maximally tilted-up state.

FIG. 6 is a cross-sectional view of the display unit and the key operation section when viewed from a side thereof (a cross-sectional view taken along line VI-VI of FIG. 5), where the display unit is in the maximally tilted-up state.

FIGS. 7(a) and 7(b) are diagrams illustrating the display unit. FIG. 7(a) is a front view, and FIG. 7(b) is a side view.

FIG. 8 is a perspective view, cut away along a leg portion inserting opening, of an apparatus casing.

FIG. 9 is a plan view illustrating the leg portion inserting opening and its vicinity.

FIG. 10 is a rough diagram illustrating partitions provided in the apparatus.

FIGS. 11(a) and 11(b) are rough diagrams illustrating a conventional exemplary display unit and its vicinity when viewed from a side thereof.

FIGS. 12(a) and 12(b) are rough diagrams illustrating another conventional exemplary display unit and its vicinity when viewed from a side thereof.

FIGS. 13(a) and 13(b) are rough diagrams illustrating still another conventional exemplary display unit and its vicinity when viewed from a side thereof.

### DESCRIPTION OF THE PREFERRED EMBODIMENTS

Hereinafter, embodiments of the present invention will be described with reference to the accompanying drawings. In the embodiments, the present invention is applied to a facsimile apparatus (an electronic equipment as used herein) for illustrative purposes.

Rough Structure of Facsimile Apparatus 1

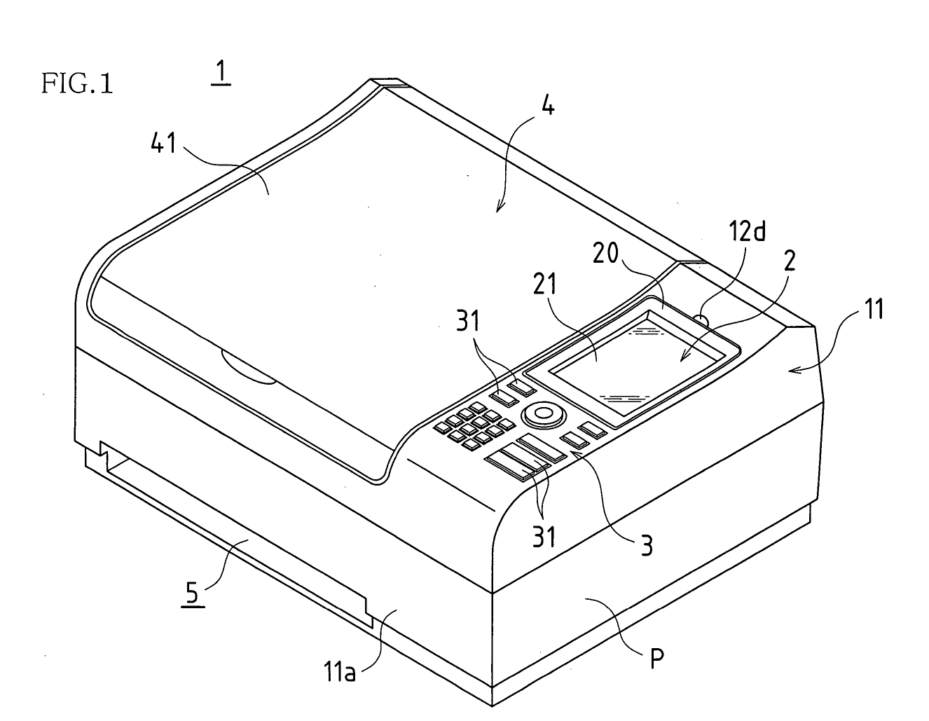

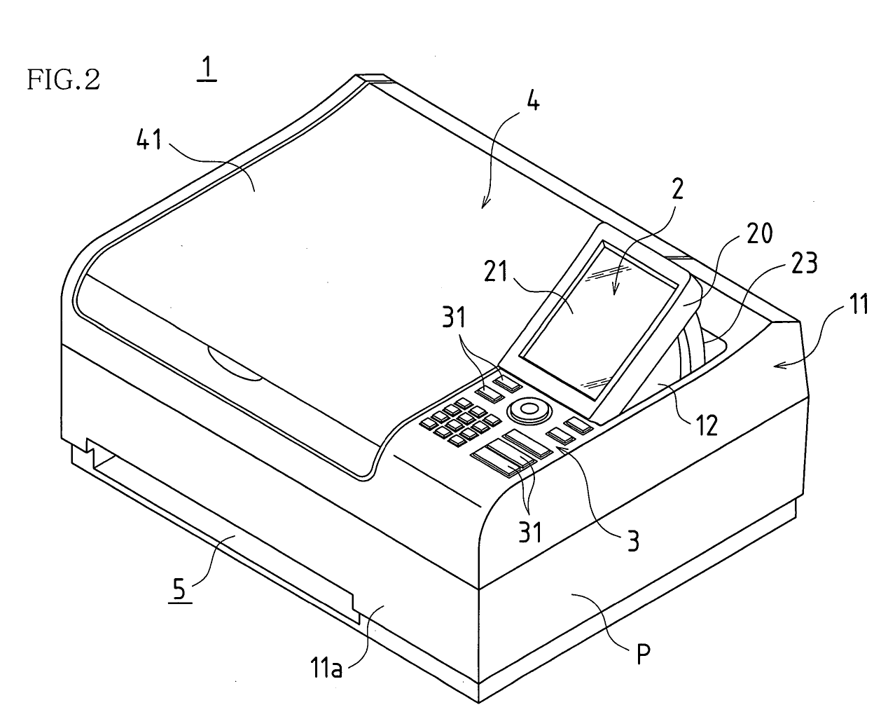

FIGS. 1 and 2 are perspective views illustrating an outer appearance of a facsimile apparatus 1 according to an embodiment of the present invention. FIG. 1 illustrates a retracted state of a display unit 2 which is a rotatable unit. FIG. 2 illustrated a maximally tilted-up state of the display unit 2.

As illustrated in FIGS. 1 and 2, the facsimile apparatus 1 of the embodiment of the present invention is provided with the display unit 2 located on a farther right-hand portion of an upper surface thereof, and a key operation section 3 located closer to a front end thereof (to the user). In other words, user interfaces are concentrated on a right-hand side portion of the upper surface of the apparatus so that satisfactory operability is provided for the user. Also, a scanner section 4 for reading an original image during facsimile transmission or the like is provided at a portion ranging from a middle portion over a left-hand side of an upper portion of the facsimile apparatus 1.

Further, a paper feed opening 5 for setting recording paper is formed on a front surface (vertical surface closer to the user) of the facsimile apparatus 1. A plurality of sheets of recording paper (not shown) set in the paper feed opening 5 are transported on a sheet-by-sheet basis from the top, into the facsimile apparatus 1. A predetermined image (an image received via facsimile or an image read by the scanner section 4) is printed on the recording paper by a printer mechanism (printer engine) included in the facsimile apparatus 1, which is described below. Specifically, the recording paper printed by the printer mechanism is reversed inside the facsimile apparatus 1, and after a predetermined printing operation, is output from the paper feed opening 5. The facsimile apparatus 1 of the embodiment of the present invention includes an ink jet type printer mechanism. Other types of printer mechanisms (e.g., an electrophotographic type) may be included.

Hereinafter, each part of the facsimile apparatus 1 will be described in detail.

Display Unit 2

The display unit 2 is a so-called portrait-type display panel in which the length dimension is longer than the width direction. Specifically, in the display unit 2, a portrait-type LCD panel 21 having a length-to-width ratio of 4:3 is housed in a unit casing 20 made of resin. The display unit 2 is supported in a manner which allows the display unit 2 to be freely tilted up and down with respect to an upper surface of the facsimile apparatus 1 (see FIG. 2).

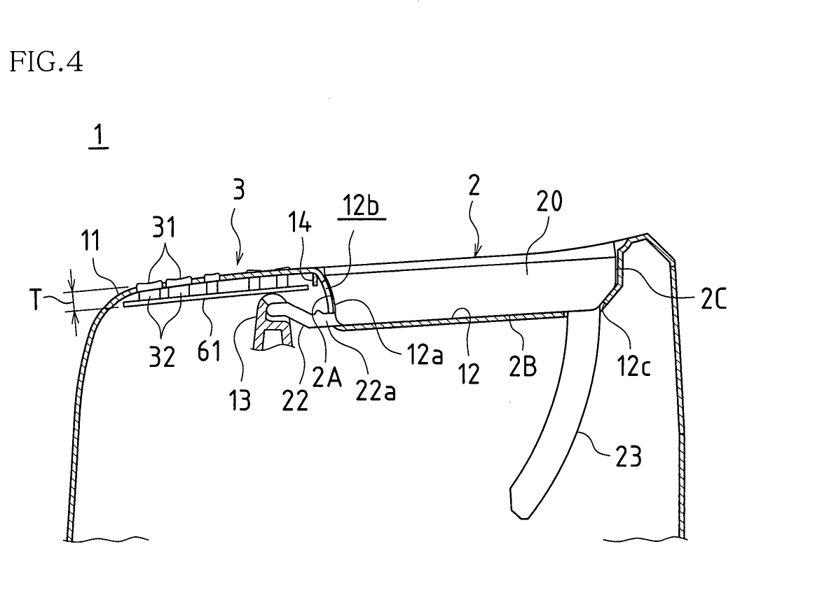

Further, as illustrated in FIG. 4 (a cross-sectional diagram of the display unit 2 and the key operation section 3 when viewed from a side thereof), a front end surface 2A (a surface facing toward the key operation section 3 in the retracted state) of the unit casing 20 of the display unit 2 is formed as a curved surface which is bent gradually closer to the key operation section 3 toward the upper surface of the apparatus in the retracted state. A hollow portion 12 for accommodating the display unit 2 in the retracted state is formed in the upper surface of the apparatus casing 11 (equipment casing). A vertical wall 12a at the front end of the hollow portion 12 is also formed as a curved surface which is bent gradually closer to the key operation section 3 toward the upper surface of the apparatus. Thereby, when the display unit 2 is in the retracted state, a gap at a front side of the display unit 2 (a gap between the front end surface 2A of the display unit 2 and the vertical wall 12a of the hollow portion 12) is substantially not visually recognized when viewed externally, resulting in a satisfactory outer appearance of the apparatus.

Note that specific outer dimensions of the display unit 2 (dimensions of the unit casing 20) include a width direction of about 96 mm, a length dimension of about 134 mm, and a thickness dimension of about 20 mm. A depth dimension of the hollow portion 12 is substantially equal to the thickness dimension of the display unit 2, so that the upper surface of the apparatus casing 11 and the upper surface of the display unit 2 are on substantially the same plane when the display unit 2 is in the retracted state. Therefore, an appearance of the facsimile apparatus 1 in the retracted state is improved. Note that details of a mechanism of supporting the display unit 2 will be described below.

The LCD panel 21 has a conventionally well-known configuration of a clear cover, an LCD module, an LCD holder, a diffusion sheet, a backlight LED, and the like (not shown). The LCD panel 21 displays information, such as a current operation status of the facsimile apparatus 1 (displays, such as “scanning”, “transmitting facsimile”, and the like), the facsimile number of the party at the other end of communication, a received facsimile image, and the like. Note that the displayed information is not limited to these.

Key Operation Section 3

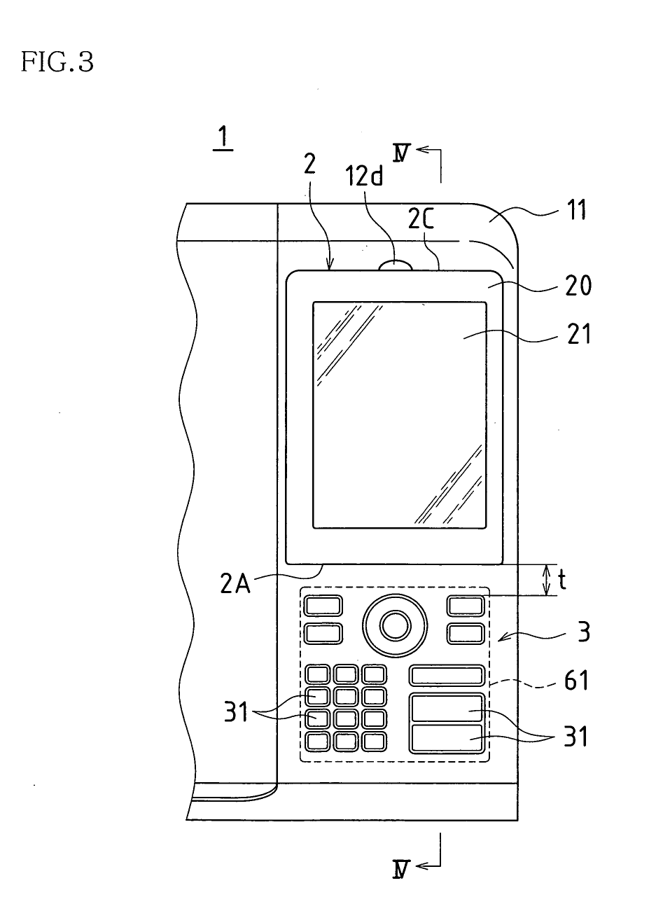

The key operation section 3 is provided with a numeric keypad, and in addition, various keys, such as a mode selection key, a cancel key, and the like. The key operation section 3 is provided with keytops 31 and rubber keys 32 as illustrated in FIG. 4. A key operation section control circuit substrate 61 is provided under the rubber key 32 inside the apparatus casing 11. The key operation section control circuit substrate 61 is parallel to the upper surface of the apparatus casing 11 and is substantially horizontal, and has substantially a rectangular shape when viewed from the top, which is substantially congruent to a region in which the key operation section 3 is formed, as illustrated with a dashed line in FIG. 3 (a plan view of an user interface portion of the display unit 2 in the retracted state).

The rubber key 32 abuts an upper surface of the key operation section control circuit substrate 61. Therefore, when the user presses down the keytop 31, a lower surface of the rubber key 32 is short-circuited with a carbon pattern printed on the upper surface of the key operation section control circuit substrate 61, so that a switch is turned ON and a predetermined command signal (a command signal caused by a key operation) is transmitted to a CPU (not shown).

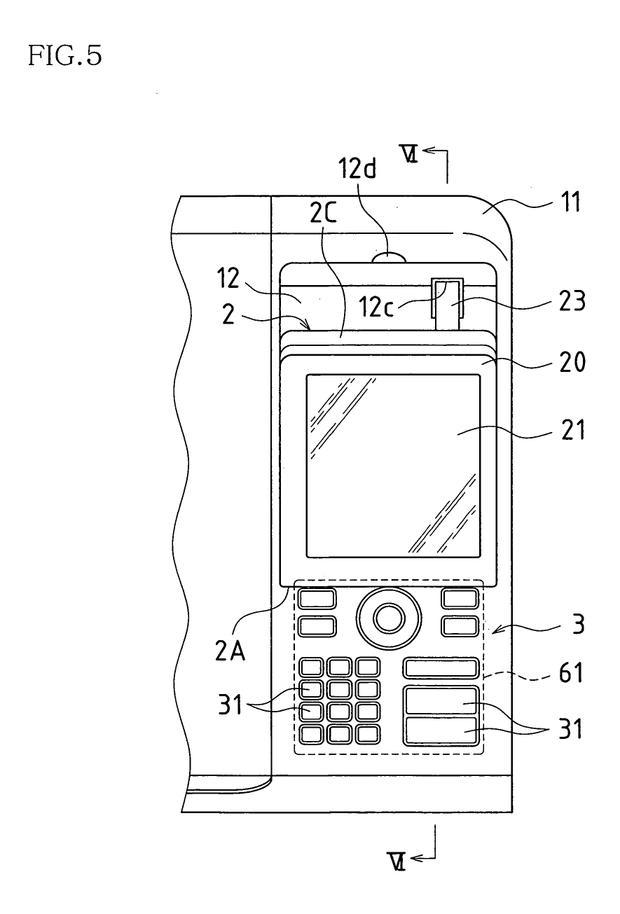

There is a predetermined dimension (a dimension t in FIG. 3) between a farthest one (closest to the display unit 2) of the keys provided on the key operation section 3, and a front end edge of the hollow portion 12 provided on the upper surface of the apparatus casing 11. In the supporting mechanism (described below) for the display unit 2, when the display unit 2 is tilted up, the lower end of the display unit 2 is moved (jutted) toward the key operation section 3 (see FIG. 5 which is a plan view illustrating a tilted-up state of the display unit 2). Thus, the dimension t is provided so as to prevent the lower end of the display unit 2 from overlapping the keys when the display unit 2 is tilted up. In this case, when a portion of hard keys 33 closer to the lower end of the display unit 2 in the key operation section 3 (keys close to the display portion) is caused to correspond to soft keys (function keys displayed as GUI) displayed at a lower portion of the display unit 2, the soft keys and the hard keys corresponding to each other have a closer distance, so that their relationship can be easily visually recognized. In other words, the user can easily understand the correspondence relationship between the soft keys and the corresponding hard keys, to clearly specify a key which requires an operation.

Scanner Section 4

The scanner section 4 is a section which reads an image of an original placed on an original placement stage (not shown) made of transparent glass or the like to create image data, and comprises an exposing light source, an imaging lens, a photoelectric conversion element (CCD: Charge Coupled Device), and the like (not shown). Further, on the original placement stage, a cover 41 which is rotatably supported by a rotation axis extending horizontally at a farther end of the facsimile apparatus 1, is provided. By closing the cover 41 (a closed state of the cover 41 is showed in FIGS. 1 and 2), an original placed on the original placement stage is pressed against the original placement stage.

Supporting Mechanism for Display Unit 2

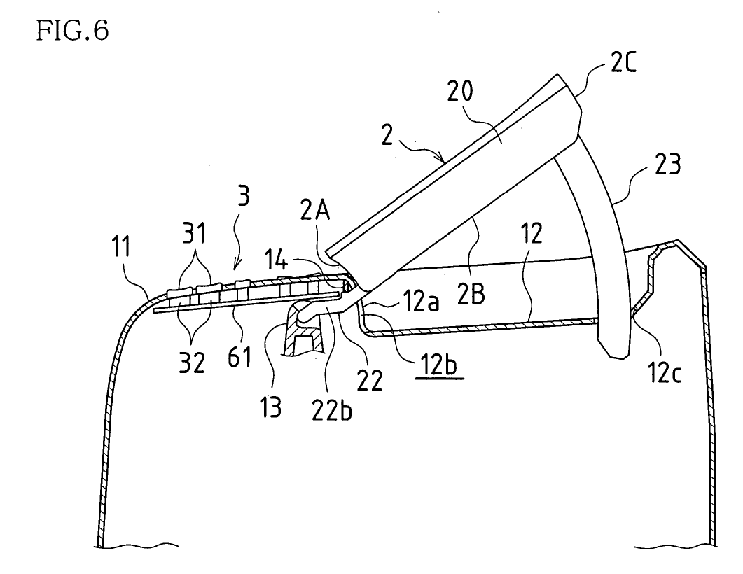

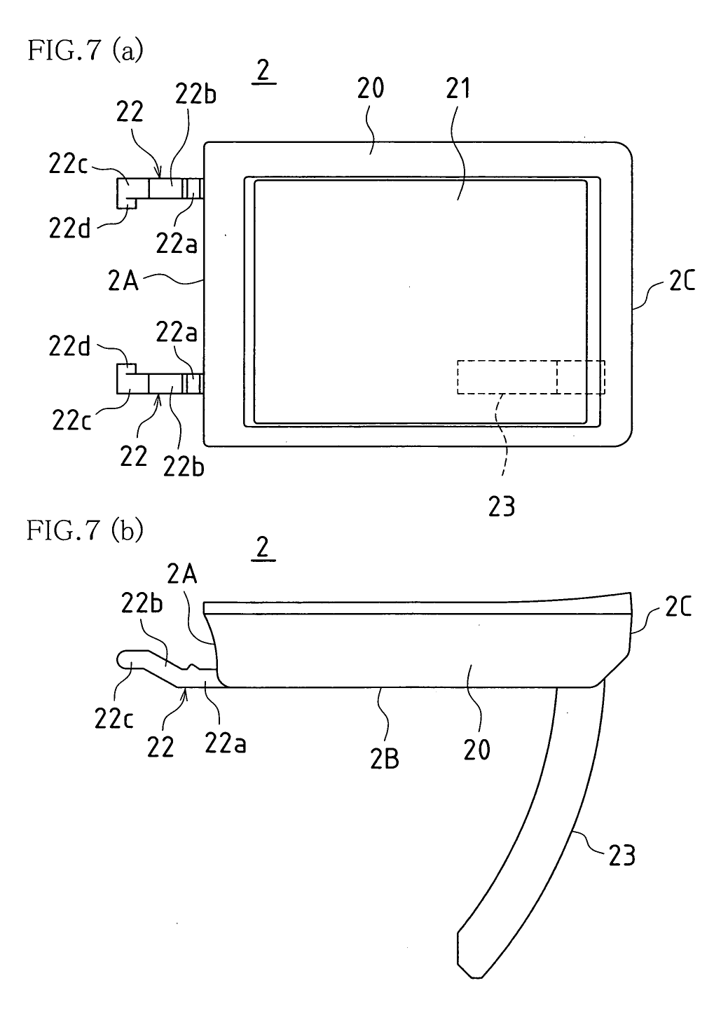

Next, the supporting mechanism for rotatably supporting the display unit 2 will be described. FIG. 3 is a plan view illustrating a right-hand portion (user interface portion) of the facsimile apparatus 1 when the display unit 2 is in the retracted state. FIG. 4 is a cross-sectional view of the display unit 2 and the key operation section 3 when viewed from a side thereof, where the display unit 2 is in the retracted state (a cross-sectional view taken along with line IV-IV in FIG. 3). FIG. 5 is a plan view illustrating the right-hand portion (user interface portion) of the facsimile apparatus 1 when the display unit 2 is in the maximally tilted-up state. FIG. 6 is a cross-sectional view of the display unit 2 and the key operation section 3 when viewed from a side thereof, where the display unit 2 is in the maximally tilted-up state (a cross-sectional view taken along with line VI-VI in FIG. 5). FIGS. 7(a) and 7(b) are diagrams illustrating the display unit 2. FIG. 7(a) is a front view and FIG. 7(b) is a side view. Note that, in the following description, when the display unit 2 is in the retracted state, a user side (a side closer to the user of the apparatus) is referred to as a front, while an opposite side (a farther side of the apparatus) is referred to as a rear. Therefore, when the display unit 2 is in the retracted state, a surface facing the key operation section 3 is referred to as a front surface or a front end surface, while a surface facing the rear side of the apparatus is referred to as a rear surface or a rear end surface. A display surface of the LCD panel 21 is referred to as an upper surface or a display surface, while a surface opposite to the display surface (a lower surface in the retracted state) of the LCD panel 21 is referred to as a lower surface or a back surface.

As illustrated in FIGS. 4, 6, 7(a), and 7(b), a pair of left- and right-hand arms 22 and 22 extending forward from a lower portion of the front end surface 2A are integratedly formed on the front end surface 2A of the display unit 2. The arm 22 is shaped so that, as illustrated in FIG. 7(b), the arm 22 comprises a first horizontal portion 22a extending horizontally from the lower portion of the front end surface 2A of the display unit 2, an inclined portion 22b extending in an upward slanting direction from a front end of the first horizontal portion 22a, and a second horizontal portion 22c further extending in the horizontal direction from a front end of the inclined portion 22b, assuming that the display unit 2 is positioned extending in a horizontal direction, i.e., the display unit 2 is in the retracted state. Further, a rotation axis member 22d having substantially a cylindrical shape is integratedly formed on a side surface of a front edge portion of the second horizontal portion 22c (a surface facing the second horizontal portion 22c of the other arm 22).

The display unit 2 is rotatably supported by hinge bases 13 and 13 (the hinge bases constituting the supporting mechanism as used herein) so that the display unit 2 can be rotated about the rotation axis members 22d and 22d formed at tips of the arms 22 and 22 as the center of rotation (see FIGS. 4 and 6). A pair of the left- and right-hand hinge bases 13 and 13 corresponding to the rotation axis members 22d and 22d of the arms 22 and 22 are integratedly formed on the apparatus casing 11 of the facsimile apparatus 1, and an opening for inserting the rotation axis member 22d is formed at a middle portion of each hinge base 13. Specifically, the rotation axis member 22d of one of the arms 22 is inserted into and supported by the opening of the corresponding one of the hinge bases 13 and 13, while the rotation axis member 22d of the other arm 22 is inserted into and supported by the opening of the other hinge base 13. The display unit 2 is rotatably supported by these supporting portions as rotation centers with respect to the apparatus casing 11.

As illustrated in FIGS. 4 and 6, the embodiment of the present invention is characterized in that the key operation section control circuit substrate 61 is provided close to the key operation section 3, and the hinge base 13 is provided under (on a back side of) the key operation section control circuit substrate 61. Specifically, the rotation axis members 22d and 22d of the arms 22 and 22 are rotatably supported by the respective hinge bases 13 and 13 provided under the key operation section control circuit substrate 61, and the rotation center of the display unit 2 is closer to a bottom portion of the facsimile apparatus 1 than the key operation section control circuit substrate 61 is.

More specifically, openings 12b for inserting the respective arms 22 and 22 are formed on the vertical wall 12a at the front end of the hollow portion 12 for accommodating the display unit 2 when the display unit 2 is in the retracted state. The openings 12b are relatively large so that the arms 22 and 22 are allowed to move from the retracted state (FIG. 4) to the maximally tilted-up state (FIG. 6) of the display unit 2 (the arms 22 and 22 are not interfered). The display unit 2 in the maximally tilted-up state is tilted at an angle of, for example, 32.5° with respect to a horizontal plane. A stopper 14 which the first horizontal portion 22a of the arm 22 abuts when the display unit 2 is tilted up to such a position, is provided in the apparatus casing 11. Also, when the display unit 2 is at such a position, the first horizontal portion 22a of the arm 22 abuts an upper edge of the opening 12b, thereby blocking further rotation. As described above, by setting the maximum tilt-up angle, the display unit 2 in the maximally tilted-up state has a height dimension of about 72 mm from the upper surface of the apparatus casing 11. Note that the maximum tilt-up angle is not limited to the above-described angle, and may be set to be within an angle range in which satisfactory visibility can be achieved for the user.

A relationship between a rotational position of the display unit 2 and the portions 22a, 22b, and 22c of the arm 22 will be described. When the display unit 2 is in the retracted state, the first horizontal portion 22a is in a horizontal state as illustrated in FIG. 4, so that the arm 22 does not protrude below a lower edge of the first horizontal portion 22a. Therefore, a layout can be achieved so that other parts can be provided directly below the hinge mechanism, resulting in effective use of space in the apparatus casing 11. On the other hand, when the display unit 2 is in the maximally tilted-up state, the inclined portion 22b is in a horizontal state, and is considerably close to, and parallel to, the lower surface of the key operation section control circuit substrate 61 as illustrated in FIG. 6. Therefore, a gap between the inclined portion 22b and the key operation section control circuit substrate 61 can be narrowed to the extent possible without a contact therebetween. Thereby, it is also possible to achieve effective use of space. To achieve a structure which has these effects, an angle attained by the first horizontal portion 22a and the inclined portion 22b and an angle attained by the inclined portion 22b and the second horizontal portion 22c, are each caused to be equal to a tilt angle (the above-described 32.5°) of the display unit 2 in the maximally tilted-up state.

On the other hand, a leg portion 23 for holding a tilted-up state of the display unit 2 is integratedly formed on a back surface 2B of the display unit 2. The leg portion 23 is made of a plate material having substantially an arc shape when viewed from a side (a shape viewed along a direction of the rotation axis; see FIG. 7(b)). An upper end of the leg portion 23 is connected to the display unit 2 at a position located on the back surface 2B of the display unit 2, the position being close to a rear end surface 2C of the display unit 2, and to a right-hand end of the display unit 2 when viewed from the top (vicinity of an end in a width direction of the apparatus casing 11; see a dashed line in FIG. 7(a)). The center of the arc of the arc-shaped leg portion 23 coincides with the center of the rotation axis member 22d (the center of rotation when the display unit 2 is tilted up).

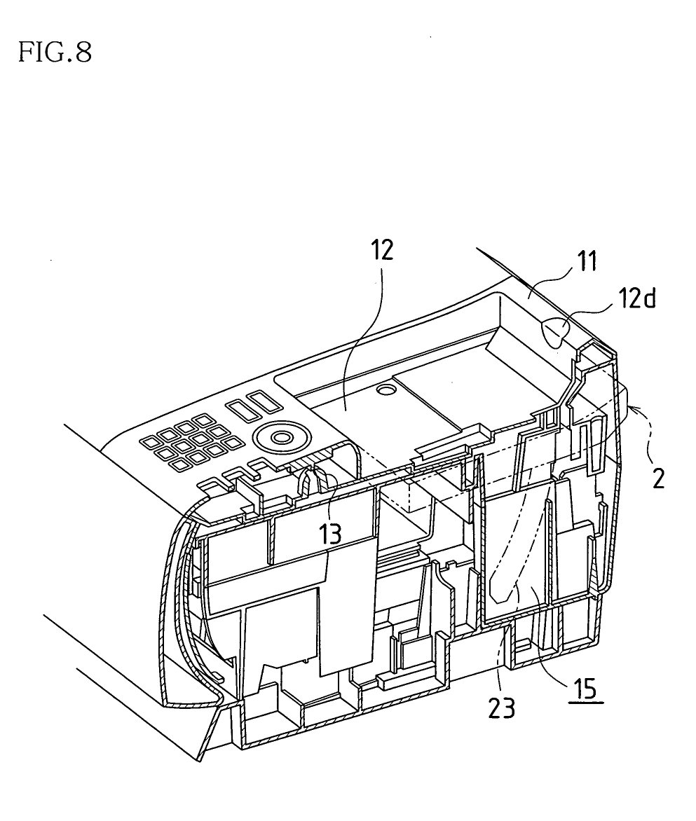

A mechanism of holding the tilted-up state of the display unit 2 by utilizing the leg portion 23 will be described as follows. A leg portion inserting opening 12c for inserting the leg portion 23 is formed at a portion of a bottom surface of the hollow portion 12 formed in the apparatus casing 11 (a hollow portion for accommodating the display unit 2), which corresponds to the leg portion 23. FIG. 8 is a perspective view, cut away along the leg portion inserting opening 12c, of the apparatus casing 11. As illustrated in FIG. 8, a leg portion accommodating space 15 for accommodating the leg portion 23 is provided in the apparatus casing 11. The leg portion accommodating space 15 is separated from other components (the printer mechanism, the control circuit substrate, etc.) of the facsimile apparatus 1 by a partition 7. The partition 7 will be described below.

A mechanism of holding an attitude of the tilted-up display unit 2 is provided in the vicinity of the leg portion inserting opening 12c. This holding mechanism holds the tilted-up state by sandwiching the leg portion 23 extending from the back surface of the display unit 2 in a thickness direction of the leg portion 23.

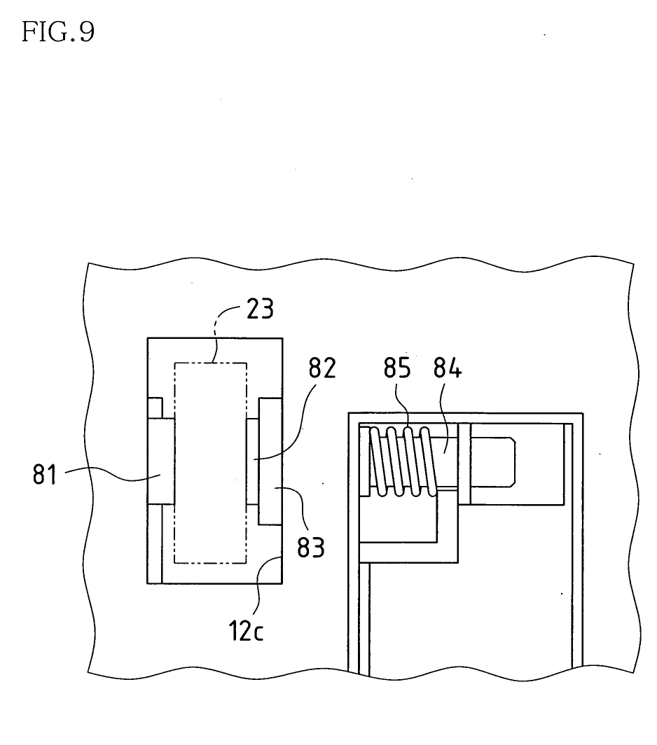

Specifically, as illustrated in FIG. 9 (a plan view of the leg portion inserting opening 12c and its vicinity), a fixed pad 81 which abuts one side of the leg portion 23 (indicated with an imaginary line in FIG. 9) and a movable pad 82 which abuts the other side of the leg portion 23, are provided. The fixed pad 81 is immovably fixed to the apparatus casing 11 at a deep portion of the leg portion inserting opening 12c. On the other hand, the movable pad 82 is opposed to the fixed pad 81 and is held by a pad holder 83. The pad holder 83 is provided with a pin 84 inserted in an opening formed on the apparatus casing 11. A coil spring 85 is attached at an outer circumferential portion of the pin 84. The coil spring 85 is mounted and contracted between the pad holder 83 and the apparatus casing 11. The biased force of the coil spring 85 acts on the pad holder 83, causing the pad holder 83 to move toward the fixed pad 81. Thereby, the movable pad 82 is pressed toward the fixed pad 81, so that the leg portion 23 is sandwiched between the fixed pad 81 and the movable pad 82. With such a structure, the tilted-up state of the display unit 2 can be held at any angle. Note that, as described above, the upper end of the leg portion 23 is located on the back surface 2B of the display unit 2 and in the vicinity of the rear end surface 2C of the display unit 2 (a location at which the radius of rotation is largest), and therefore, the tilted-up state can be sufficiently held by applying a relatively small level of force of sandwiching the leg portion 23 by the pads 81 and 82. Also, as described above, the center of the arc of the leg portion 23 coincides with the center of the rotation axis member 22d (the center of rotation when the display unit 2 is tilted up), and therefore, the leg portion 23 passes through only a constant portion (indicated with an imaginary line in FIG. 9) of the leg portion inserting opening 12c when the display unit 2 is tilted up. Therefore, the opening shape of the leg portion inserting opening 12c only needs to be slightly larger than a cross-sectional shape of the leg portion 23, resulting in a small opening area. In addition, the pads 81 and 82 can have a small shape.

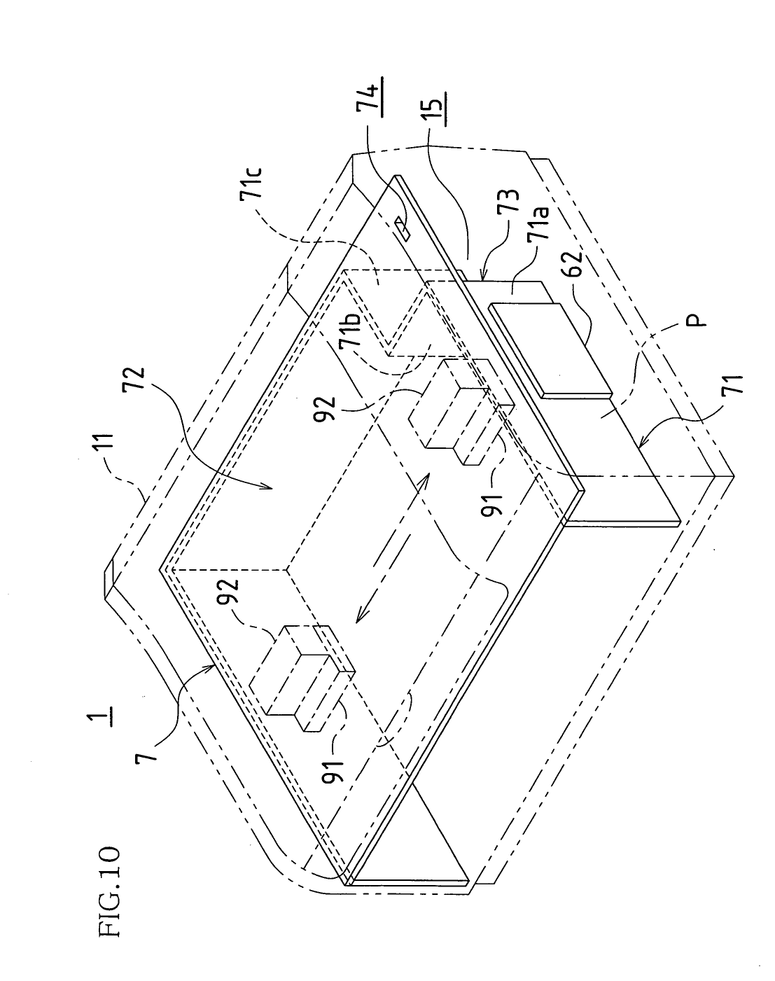

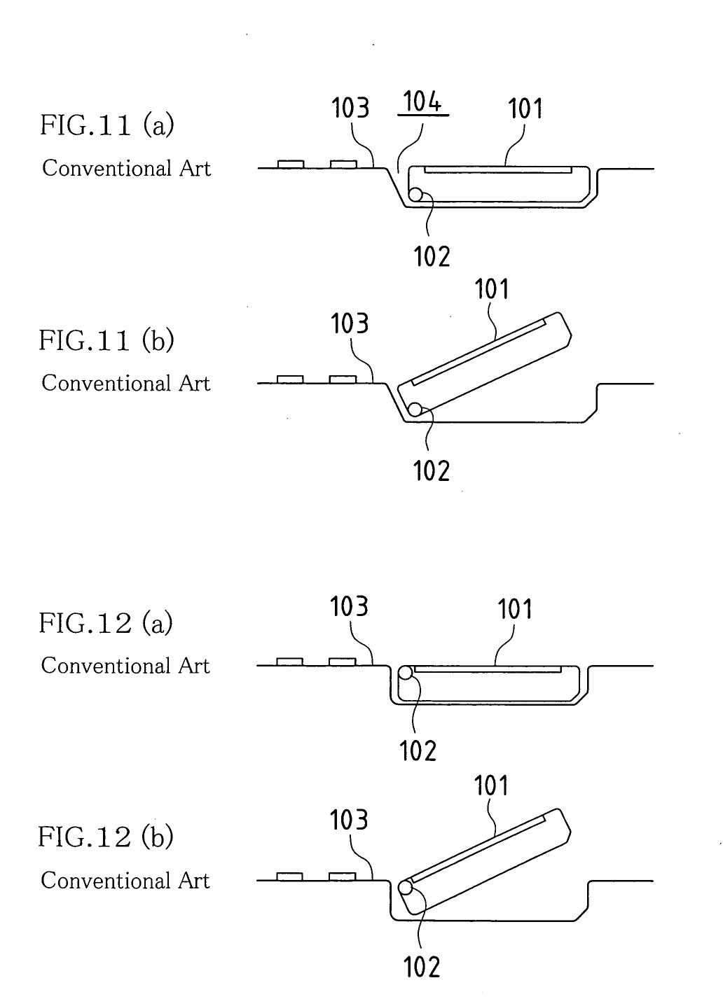

Next, a rough structure of the partition 7 will be described with reference to FIG. 10. In FIG. 10, only the partition 7 and a display unit control circuit substrate 62 described below are indicated with a solid line, an outer appearance of the apparatus casing 11 is indicated with an imaginary line, and an ink jet head 91 and a cartridge 92 of the printer mechanism are indicated with a dash dot line. The ink jet head 91 and the cartridge 92 perform printing by ejecting ink droplets onto recording paper while being reciprocally moved in a lateral direction (a main scanning direction) during printing operation. A left-hand end in the main scanning direction of FIG. 10 is a home position of the ink jet head 91 and the cartridge 92. A right-hand end of FIG. 10 is a position where the cartridge 92 is exchanged as required. In FIG. 10, the shape of the partition 7 is simplified for ease of understanding a structure and a function thereof.

As illustrating in FIG. 10, the partition 7 comprises a vertical partition 71 and a horizontal partition 72. The vertical partition 71 is composed of a plurality of vertical walls, and its main function is to separate the printer mechanism from the leg portion accommodating space 15. On the other hand, the horizontal partition 72 is composed of a horizontal wall extending in a horizontal direction, and its main function is to separate the printer mechanism from the scanner section 4 and the key operation section control circuit substrate 61. Details thereof will be described.

The vertical partition 71 is composed of a plurality of vertical walls which surround both left- and right-hand sides of the printer mechanism and the farther side of the apparatus, leaving a side facing the front of the apparatus open. This open portion is linked to the paper feed opening 5, so that paper can be fed from the front side of the apparatus. Since the vertical partition 71 is not provided at the front portion of the apparatus, by opening a front panel 11a (see FIG. 1) of the apparatus casing 11, the accommodation space of the printer mechanism can be accessed from the front of the apparatus, whereby a task, such as cartridge exchange or the like, can be performed from the front side of the apparatus.

The vertical partition 71 is also provided with a bend portion 73 for partitioning off the leg portion accommodating space 15. The bend portion 73 is provided under the place where the display unit 2 is provided, and comprises a first bent portion 71b slightly extending from a farther (rear) end of a right-hand wall 71a of the vertical partition 71 toward the inside and along the width direction of the facsimile apparatus 1, and a second bent portion 71c extending from a tip of the first bent portion 71b toward the farther side of the apparatus. The thus-shaped bend portion 73 separates the printer mechanism from the leg portion accommodating space 15 in the horizontal direction. Therefore, when scattered ink droplets are flown from the printer mechanism, the droplets can be prevented from entering the leg portion accommodating space 15 and flowing out of the apparatus via the leg portion inserting opening 12c.

Further, under a place where the key operation section 3 is provided, the right-hand wall 71a of the vertical partition 71 is slightly set back from a side panel P of the apparatus casing 11, leaving a predetermined space between the right-hand wall 71a and the side panel P. The display unit control circuit substrate 62 in its vertical attitude is accommodated in the space between the side panel P of the apparatus casing 11 and the right-hand wall 71a. Thereby, at this portion, the printer mechanism and the display unit control circuit substrate 62 are separated from each other in the horizontal direction. In other words, scattered ink droplets flown from the printer mechanism are prevented from being attached to the display unit control circuit substrate 62 and leading to malfunction.

On the other hand, the horizontal partition 72 extends in the horizontal direction so as to cover an entire upper side of a space surrounded by the vertical partition 71 (a space accommodating the printer mechanism), and also covers above the bend portion 73 of the vertical partition 71. In other words, the horizontal partition 72 functions as an upper wall of the leg portion accommodating space 15. The scanner section 4 and the key operation section control circuit substrate 61 are provided over the vertical partition 71, and the printer mechanism is vertically separated from the scanner section 4 and the key operation section control circuit substrate 61. Therefore, scattered ink droplets flown from the printer mechanism are prevented from entering the scanner section 4 and leading to troubles in the image reading operation, or being attached to the key operation section control circuit substrate 61 and leading to malfunction of the apparatus. Note that an opening 74 for passing the leg portion 23 is provided at a position corresponding to the leg portion inserting opening 12c on the horizontal partition 72.

Tilt-Up Operation of Display Unit 2

Next, a tilt-up operation of the display unit 2 in the facsimile apparatus 1 constructed as described above will be described.

Firstly, in order to tilt up the display unit 2 to improve the visibility of the LCD panel 21 when the display unit 2 is in the retracted state as illustrated in FIG. 1, the user holds the rear edge of the display unit 2 and rotates the display unit 2 by pulling the rear edge toward the user. An insert portion 12d for the user inserting a finger during the tilt-up operation is formed on a vertical wall at the rear end of the hollow portion 12. The user inserts a finger into the insert portion 12d, thereby holding the rear edge of the display unit 2. By this tilt-up operation, the display unit 2 is rotated about the axis of rotation of the rotation axis members 22d and 22d provided on the arms 22 and 22 to be tilted up. Along with this tilt-up operation, the leg portion 23 integratedly formed on the back surface of the display unit 2 is gradually pulled out from the leg portion inserting opening 12c while being sandwiched by the pads 81 and 82 and being slid with respect to the pads 81 and 82.

Also, as described above, both the front end surface 2A of the unit casing 20, and the vertical wall 12a of the hollow portion 12 facing the front end surface 2A, are formed as curved surfaces which are slightly bent closer to the key operation section 3 toward the upper surface of the apparatus. Therefore, during the tilt-up operation, the display unit 2 is rotated without touching (interfering with) the vertical wall 12a of the hollow portion 12 (see FIG. 6).

Thereafter, a desired tilted-up state is obtained by the user ending the operation at a desired tilted-up position. At this time, since the leg portion 23 is sandwiched by the pads 81 and 82, the tilted-up state is stably held. Particularly, when the portrait-type display unit 2 is employed as in the embodiment of the present invention, the distance between the rotation axis and the center of gravity position is longer than that of a landscape-type one, so that the rotational moment due to gravity is likely to be significant. Nevertheless, the holding mechanism employing the pads 81 and 82 (the tilted-up state is held by sandwiching the leg portion 23 on a rotation path which is located closer to the circumference than the center of gravity position of the display unit 2 is) can stably hold the tilted-up state.

Also, as described above, the center of rotation of the display unit 2 is provided under the key operation section 3 and under the key operation section control circuit substrate 61, so that the lower end (front end surface) of the display unit 2 is moved (jutted) toward the key operation section 3 along with the tilt-up operation (see FIGS. 5 and 6). In other words, the display unit 2 approaches the key operation section 3, so that, after the display unit 2 is tilted up, keys can be satisfactorily operated while viewing the LCD panel 21.

Further, since the display unit 2 is rotatably supported via the arm 22, the distance between the center of rotation of the display unit 2 and the rear end surface 2C (the upper surface when tilted up) of the display unit 2 can be caused to be long. Thereby, the rotation angle of the hinge mechanism with respect to a movement distance in a rotational direction of the rear end surface 2C of the display unit 2 can be caused to be small. In addition, the distance (radius of rotation) between the center of rotation and the rear end of the rotatable unit can be elongated due to a length of the arm, thereby making it possible to reduce force required to tilt up the rotatable unit. Therefore, the user can easily make a fine adjustment of the tilt-up angle. Particularly, in the embodiment of the present invention, this effect is significant since the portrait-type display unit 2 is employed. A particular hinge mechanism of reducing acting force for tilting up is no longer required, contributing to a reduction in size of the apparatus.

As described above, in the embodiment of the present invention, the center of rotation of the display unit 2 is provided closer to the bottom portion of the facsimile apparatus 1 than the key operation section control circuit substrate 61 is. Therefore, even if the display unit 2 is in the retracted state, and foreign matter or water enters between the front end surface 2A of the display unit 2 and the vertical wall 12a at the front end of the hollow portion 12, and enters the inside of the apparatus casing 11 via the opening 12b, the foreign matter or water can be prevented from falling on the key operation section control circuit substrate 61, so that an adverse influence on the key operation section control circuit substrate 61 can be avoided.

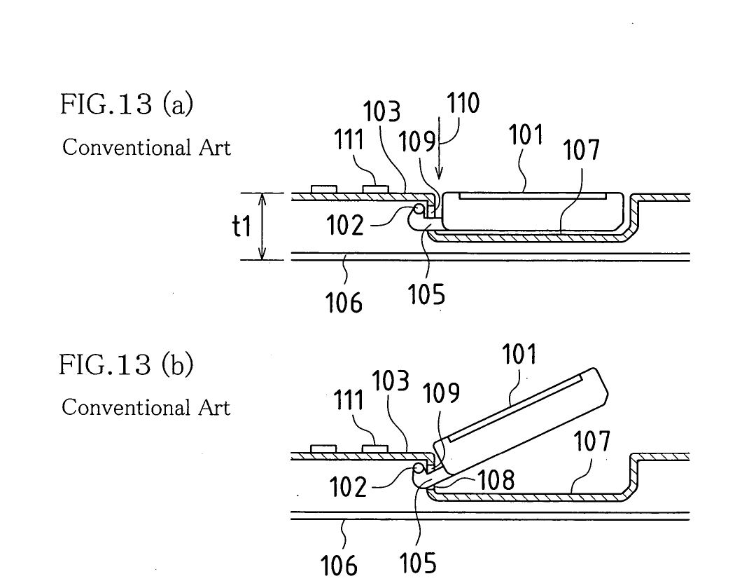

In addition, by providing the center of rotation position of the display unit 2 as described above, the keytop 31 and the rubber key 32 can be disposed at a position right above the center of rotation or closer to the display unit 2 than the position right above the center of rotation is. Specifically, as illustrated in FIGS. 4 and 6, one closest to the display unit 2 of the keytops 31 and the rubber keys 32 included in the key operation section 3 is disposed more closer to the display unit 2 than a position right above the center of rotation of the display unit 2 (a position facing the center of rotation of the display unit 2) is. When the center of rotation of a display unit is located above a control circuit substrate as in conventional technology, a keytop 111 needs to be disposed at a position farther (toward the left-hand side of FIGS. 13(a) and 13(b)) from the display unit 101 than a position right above the center of rotation (the rotation axis 102) of the display unit 101 is, as can be seen from FIGS. 13(a) and 13(b). Therefore, it is difficult to increase an area in which keys can be arranged. By contrast, according to the embodiment of the present invention, the keytop 31 and the rubber key 32 can be provided in a region in which keys cannot be conventionally arranged, thereby making it possible to increase an area in which keys can be arranged. Therefore, the size of the keytop 31 and the degree of freedom of key pitch layout can be increased. As a result, a large-size keytop 31 can be arranged with a large key pitch, thereby making it possible to provide the key operation section 3 which the user can easily operate.

When an attempt is made to increase an amount of how much the display unit 2 is jutted in the tilted-up state, lengths of the arms 22 and 22 are set to be long. Also, the center of rotation of the display unit 2 needs to be provided in the vicinity of the bottom portion of the facsimile apparatus 1 in order to prevent a gap from occurring between the lower end of the display unit 2 and the upper surface of the apparatus casing 11 in the tilted-up state. In this case, if the center of rotation of a display unit is located above a control circuit substrate as in the conventional technology, the control circuit substrate also needs to be provided in the vicinity of the bottom portion of the apparatus, so that a distance between the keytop and the control circuit substrate is caused to be long, likely leading to an increase in size of a key operation section (an increase in thickness of the key operation section; see the dimension t1 in FIG. 13(a)) or a failure in transfer of key operation force. In contrast to this, if the center of rotation of the display unit 2 is provided closer to the bottom portion of the facsimile apparatus 1 than the key operation section control circuit substrate 61 is as in the embodiment of the present invention, the center of rotation position does not have an influence on the distance between the keytop 31 and the key operation section control circuit substrate 61. Therefore, the miniaturization of the key operation section 3 (a reduction in thickness dimension of the key operation section 3; see a dimension T in FIG. 4) can lead to a reduction in thickness of the whole facsimile apparatus 1. In addition, the distance between the keytop and the key operation section control circuit substrate 61 can be reduced, and key operation force can be satisfactorily transferred, thereby making it possible to improve the reliability of operations.

### Other Embodiments

In the above-described embodiment of the present invention, the present invention is applied to the facsimile apparatus 1. The present invention is not limited to this, and can be applied to various electronic equipments, such as a telephone, a notebook computer, and the like, which comprise a display unit which can be freely tilted up. Also, a unit which is rotatably supported is not limited to a display unit, and may be an operation unit comprising various operation keys. The present invention can also be applied to a rotatable unit which functions as both a display unit and an operation unit.

Also, in the above-described embodiment of the present invention, the present invention is applied to the facsimile apparatus 1 in which the key operation section 3 is provided in front of the display unit 2. The present invention is not limited to this, and can be applied to an electronic equipment in which the key operation section 3 is not provided in front of the display unit 2. In other words, a control circuit substrate for a purpose other than key operation may be provided between the rotation axis member 22d of the arm 22 and the apparatus casing 11.

The center of rotation position of the display unit 2 which achieves the effect of the present invention is not limited to a position under the key operation section control circuit substrate 61, and may be a position below an imaginary plane including the plate surface of the key operation section control circuit substrate 61. The upper surface of the apparatus casing 11 is not limited to a surface extending in the horizontal direction, and may be an inclined surface.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An electronic equipment comprising:
an equipment casing;
a control circuit substrate accommodated and disposed in the equipment casing; and
a rotatable unit rotatably supported by a supporting mechanism accommodated in the equipment casing, and capable of being tilted up and down with respect to a surface of the equipment casing,
wherein the supporting mechanism is disposed closer to an opposite surface of the equipment casing than an imaginary plane including a plate surface of the control circuit substrate is.

2. The electronic equipment according to claim 1, wherein the rotatable unit comprises an arm penetrating through the equipment casing and extending inside the equipment casing, and the arm is rotatably supported by the supporting mechanism, whereby the rotatable unit is tilted up and down with a center of rotation thereof being provided closer to the opposite surface of the equipment casing than the imaginary plane is.

3. An electronic equipment comprising:
an equipment casing;
a control circuit substrate accommodated and disposed in the equipment casing; and
a rotatable unit rotatably supported by a supporting mechanism accommodated in the equipment casing, and capable of being tilted up and down with respect to an upper surface of the equipment casing,
wherein the control circuit substrate is provided extending in a horizontal direction substantially parallel to the upper surface of the equipment casing within the equipment casing, and the supporting mechanism is disposed closer to a bottom surface of the equipment casing than an imaginary horizontal plane including a plate surface of the control circuit substrate is.

4. The electronic equipment according to claim 3, wherein the rotatable unit comprises an arm penetrating through the equipment casing and extending inside the equipment casing, and the arm is rotatably supported by the supporting mechanism, whereby the rotatable unit is tilted up and down with a center of rotation thereof being provided closer to the bottom surface of the equipment casing than the imaginary horizontal plane is.

5. The electronic equipment according to any one of claims 1 to 4, wherein the equipment casing is provided with a key operation section comprising a plurality of keys, and the control circuit substrate is disposed at a position facing the key operation section in a space of the equipment casing.

6. The electronic equipment according to any one of claims 1 to 4, wherein the equipment casing is provided with a hollow portion for accommodating the rotatable unit when the rotatable unit is retracted, and a surface of the rotatable unit in the retracted state and an outer surface of the equipment casing are on substantially the same plane.

7. The electronic equipment according to claim 6, wherein a front surface of the rotatable unit facing a vertical wall of the hollow portion is formed as a curved surface bent from a back surface toward a top surface of the rotatable unit, and the vertical wall of the hollow portion is formed as a curved surface extending along the curved surface of the rotatable unit.

8. The electronic equipment according to any one of claims 1 to 4, wherein the rotatable unit is a portrait-type rotatable unit having a first dimension in a rotation axis direction and a second dimension perpendicular to the first dimension, the second dimension being longer than the first dimension.

9. The electronic equipment according to any one of claims 1 to 4, wherein the rotatable unit is composed of a display unit comprising inside a liquid crystal display apparatus.
